(19) United States
(12) Patent Application Publication
(10) Pub. No.: US 2025/0001443 A1
(43) Pub. Date: Jan. 2, 2025

(54) APPLICATOR

(71) Applicant: CARLISLE CONSTRUCTION MATERIALS, LLC, Carlisle, PA (US)

(72) Inventors: Eric DONALDSON, Oakdale, MN (US); Phil BOLEA, Oakdale, MN (US); Bruce NELSON, Oakdale, MN (US); Tom REEDER, Oakdale, MN (US); Forrest WILDE, Oakdale, MN (US); Brian CALAMAN, Carlisle, PA (US); Austin KULP, Carlisle, PA (US)

(73) Assignee: CARLISLE CONSTRUCTION MATERIALS, LLC, Carlisle, PA (US)

(21) Appl. No.: 18/576,682

(22) PCT Filed: Jul. 6, 2022
(86) PCT No.: PCT/US2022/036236

§ 371 Date: Jan. 4, 2024

Related U.S. Application Data
(60) Provisional application No. 63/219,174, filed on Jul. 7, 2021.

(51) Int. Cl. B05B 12/00; B05B 15/63

(52) U.S. Cl. CPC B05B 12/0026; B05B 12/006; B05B 15/63

(57) ABSTRACT

A plural component applicator can include a nozzle attached to a gun body. wherein the gun body comprises a manifold configured to receive a plurality of components based on operation of a trigger assembly. wherein the manifold is configured to separately deliver the plurality of components to a static mixer within the nozzle based on operation of the trigger assembly.

### BACKGROUND

This disclosure is related to a plural component applicator, and specifically to a plural component applicator that can include a nozzle attached to a gun body, wherein the gun body comprises a manifold configured to receive a plurality of components based on operation of a trigger assembly, wherein the manifold is configured to separately deliver the plurality of components to a static mixer within the nozzle based on operation of the trigger assembly.

### SUMMARY

A plural component applicator can include a nozzle attached to a gun body, wherein the gun body comprises a manifold configured to receive a plurality of components based on operation of a trigger assembly, wherein the manifold is configured to separately deliver the plurality of components to a static mixer within the nozzle based on operation of the trigger assembly.

### BRIEF DESCRIPTION OF THE FIGURES

FIG. 1 is a view of the embodiments described herein.

FIG. 2 is a side cutaway view of the embodiments described herein.

FIG. 3 is an exploded view of the embodiments described herein.

FIG. 4 is a top cutaway view of the embodiments described herein.

FIG. 5 is a top view of the embodiments described herein.

FIG. 6 is a view of a portion of the embodiments described herein.

FIG. 7 is a view of a portion of the embodiments described herein.

FIG. 8 is a view of a portion of the embodiments described herein.

FIG. 9 is a view of a portion of the embodiments described herein.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

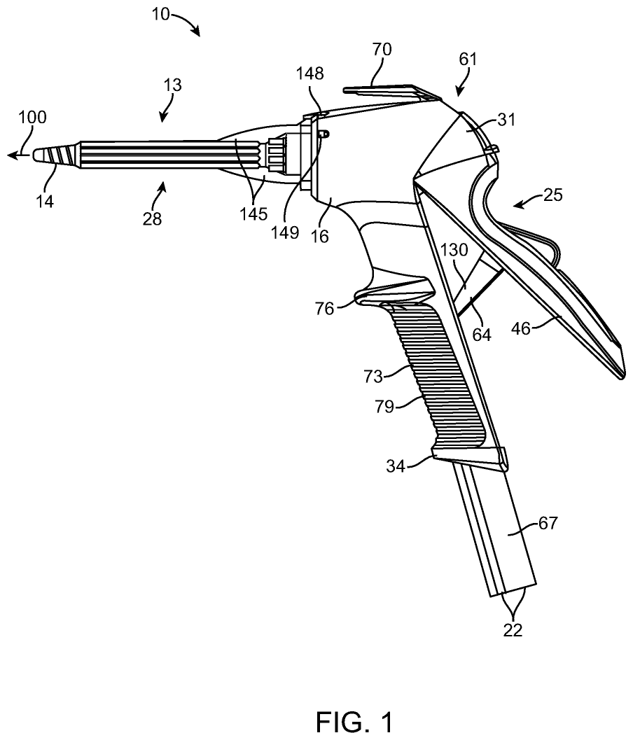

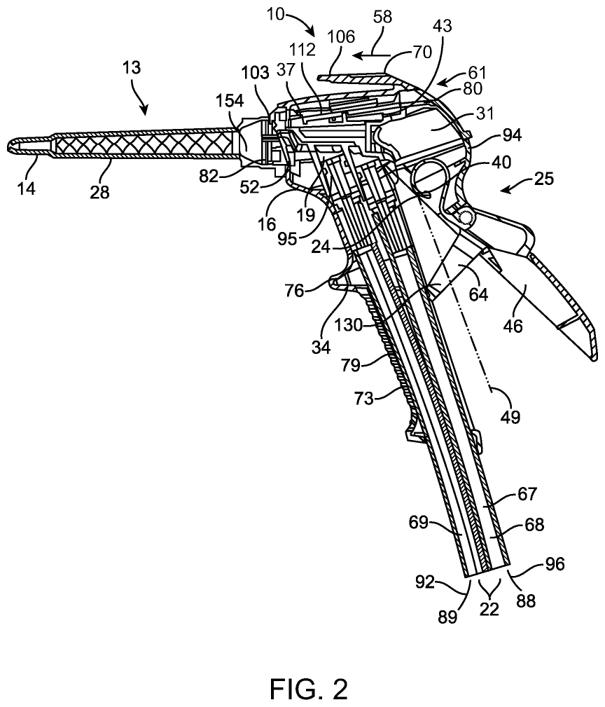

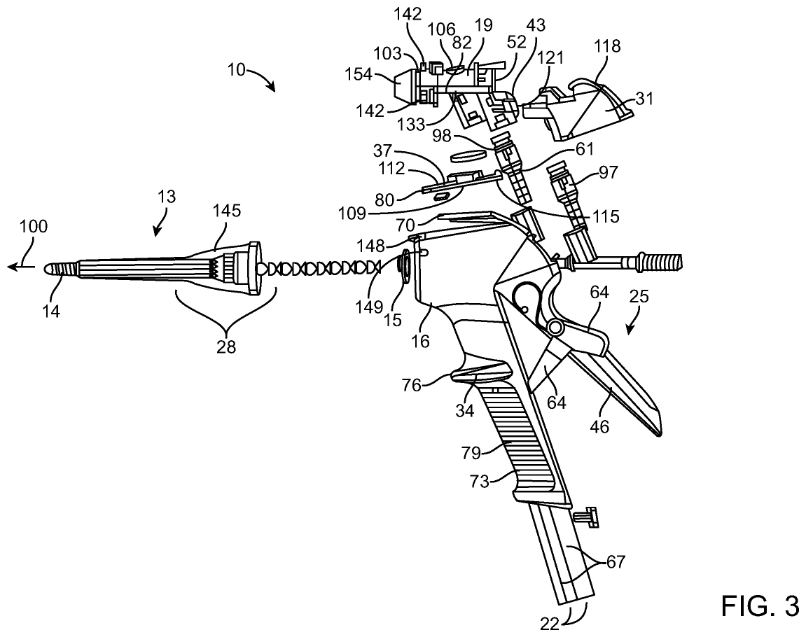

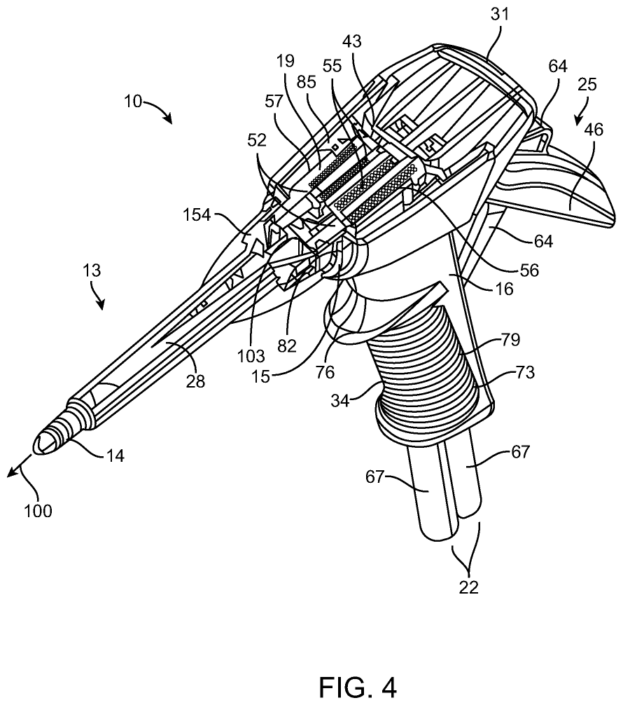

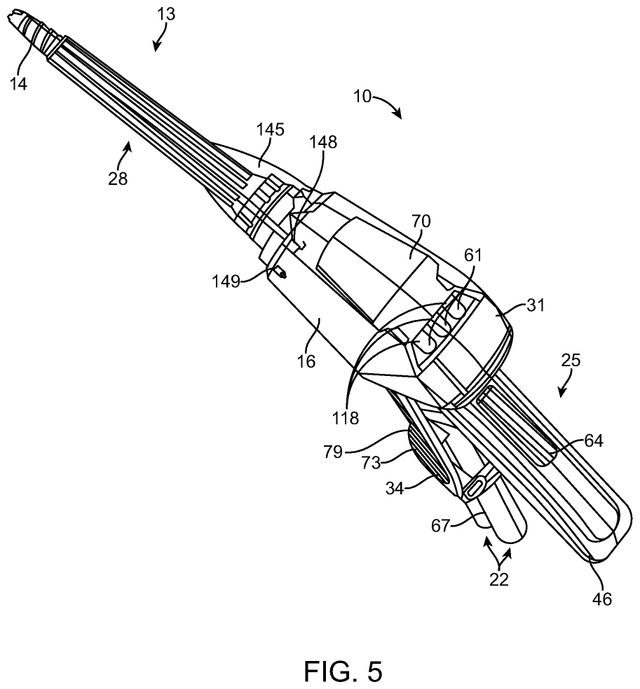

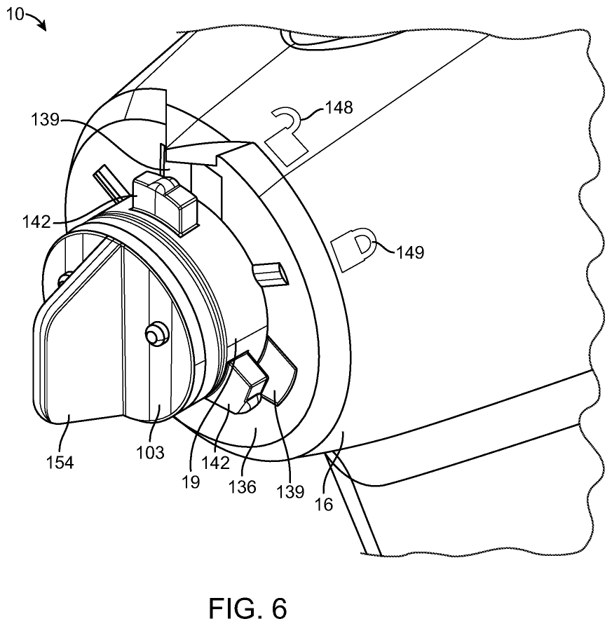

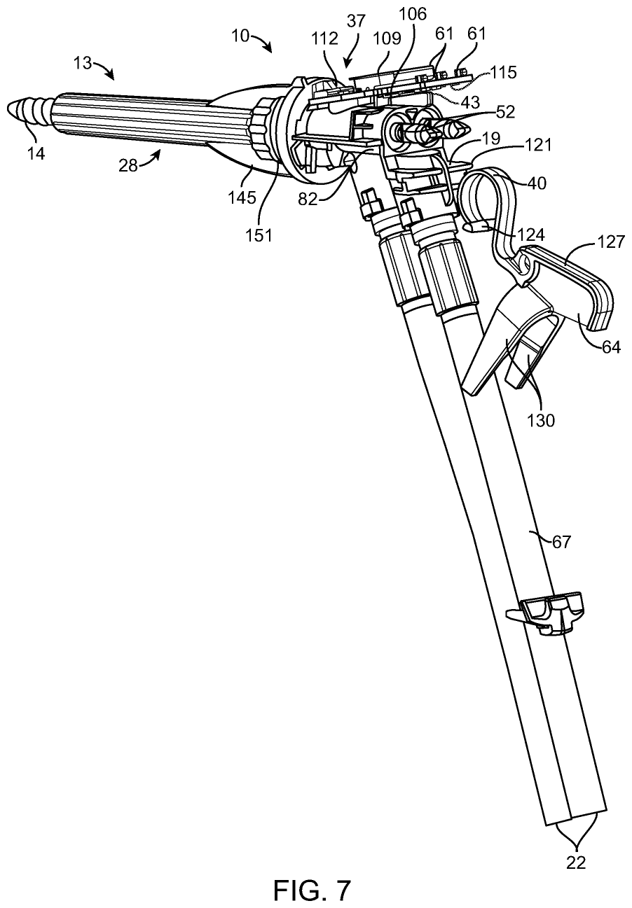

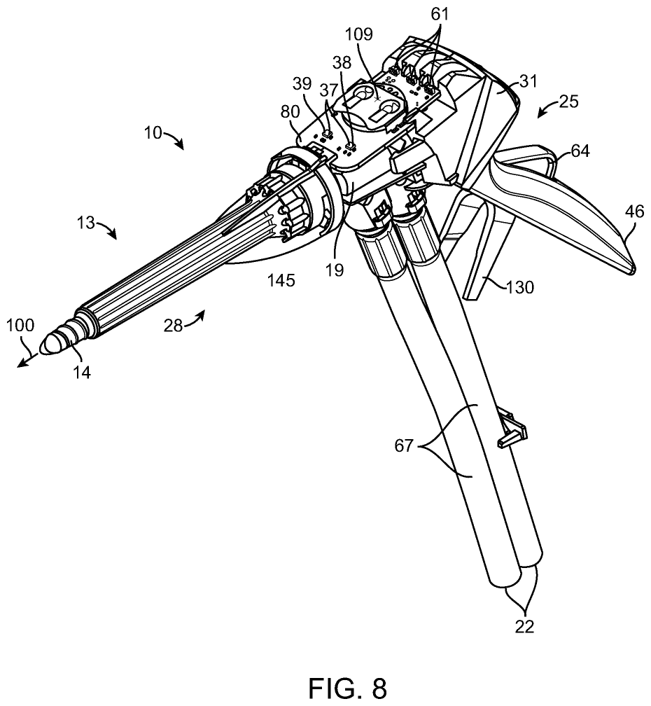

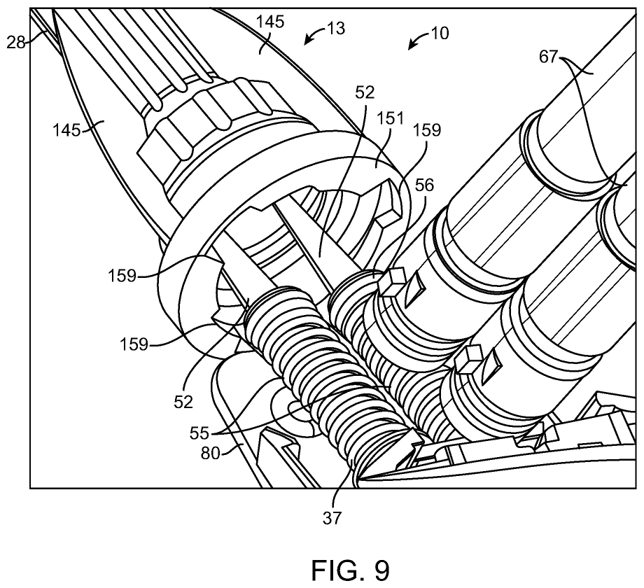

As shown in FIGS. 1-9, a plural component applicator 10 can include a nozzle 13 attached to a gun body 16, wherein the gun body 16 comprises a manifold 19 configured to receive a plurality of components 22 based on operation of a trigger assembly 25, wherein the manifold 19 is configured to separately deliver the plurality of components 22 to a static mixer 28 within the nozzle 13 based on operation of the trigger assembly 25. In some embodiments, the plural component applicator 10 can provide that the gun body 16 comprises a rear hood 31 and handle 34. In certain embodiments, the plural component applicator 10 can further provide that the manifold 19 is configured to snap fit into the handle 34 and rear hood 31. In some embodiments, the plural component applicator 10 can provide that the rear hood 31 is configured to snap fit into the handle 34. In certain embodiments, the plural component applicator 10 can further include at least one temperature sensor 37. In certain embodiments, the plural component applicator 10 can further provide that the trigger assembly 25 comprises a cam 40 configured to rotate against a rear external surface 43 of the manifold 19. In some embodiments, the plural component applicator 10 can provide that the trigger assembly 25 comprises a trigger 46 configured to increase a lever moment 49 based on actuation of the trigger 46. In certain embodiments, the plural component applicator 10 can further include a plurality of needle valves 52 and springs 55, wherein the lever moment 49 is configured to counteract an increasing force of the springs 58 based on actuation of the trigger 46 to thereby operate the needle valves 52.

According to some embodiments, the plural component applicator 10 can include at least one optical indicator 61, wherein the at least one optical indicator 61 is configured to optically transmit information related to battery power, trigger 46 actuation, temperature conditions, pressure conditions, or combinations thereof. According to some embodiments, the plural component applicator 10 can include a trigger lock mechanism 64 configured to prevent accidental actuation and dispensing. According to certain embodiments, the plural component applicator 10 can include a plurality of hoses 67, wherein the hoses 67 are configured to enter the manifold 19 through the handle 34. In some embodiments, the plural component applicator 10 can provide that the manifold 19 is configured to sacrificially and deterministically burst based on a material overpressure situation. In some embodiments, the plural component applicator 10 can provide that the applicator comprises an integral hook 70. According to some embodiments, the plural component applicator 10 can include a hand grip 73, a finger shelf 76, and surface texturing 79. According to some embodiments, the plural component applicator 10 can include a internal control unit 80 housed within the gun body 16 configured to reduce a battery drain when the applicator is not in use and to store performance information.

The plural component applicator 10 can include a first fluid 91 chamber 82 configured to receive a first fluid 91 from a first fluid source 88 through a first fluid hose 68 based on operation of a trigger 46; a second fluid chamber 85 configured to receive a second fluid from a second fluid source 89 through a second fluid hose 69 based on operation of the trigger 46; a static mixer 28 configured to receive the first fluid 91 from the first fluid 91 chamber 82 and second fluid 92 from the second fluid chamber 85 and form a third fluid 100, wherein the third fluid 100 is a mixture of the first and second fluid, a reaction product of the first and second fluid, or a combination thereof; and a nozzle tip 14 configured to output the third fluid 100. In some embodiments, the plural component applicator 10 can include a nozzle 13, wherein the nozzle 13 consists of a single piece nozzle 13 body comprising the nozzle tip 14 and the static mixer 28. In some embodiments, the plural component applicator 10 can include a manifold 19, wherein the manifold 19 comprises the first fluid 91 chamber 82 and second fluid chamber 85. In certain embodiments, the plural component applicator 10 can provide that the manifold 19 comprises an internal pressure, and wherein the manifold 19 is configured to sacrificially and deterministically burst if an internal pressure of the manifold 19 reaches a pressure of at least 500 pounds per square inch. According to certain embodiments, the plural component applicator 10 can provide that the manifold 19 is configured to sacrificially and deterministically burst if an internal pressure of the manifold 19 reaches a pressure of at least 540 pounds per square inch. According to certain embodiments, the plural component applicator 10 can provide that the manifold 19 is configured to sacrificially and deterministically burst if an internal pressure of the manifold 19 reaches a pressure of at least 600 pounds per square inch. In certain embodiments, the plural component applicator 10 can provide that the manifold 19 comprises a dividing wall 154 on a forward external surface 103 of the manifold 19 configured to segregate the first fluid 91 from the second fluid before contact with a static agitator of the static mixer 28. In some embodiments, the plural component applicator 10 can include an o-ring seal 15 attached to the forward external surface 103 of the manifold 19. In some embodiments, the plural component applicator 10 can include a internal control unit 80 and a gun body 16, wherein the internal control unit 80 is removably attached to a top external surface 106 of the manifold 19 and within the gun body 16. In certain embodiments, the plural component applicator 10 can provide that the internal control unit 80 comprises a first sensor 38 and a second sensor 39. According to certain embodiments, the plural component applicator 10 can provide that the first sensor 38 is a temperature sensor 37, pressure sensor, or combination thereof. In certain embodiments, the plural component applicator 10 can provide that the second sensor 39 is a temperature sensor 37, pressure sensor, or combination thereof, wherein the first sensor 38 is configured to detect a first condition of the first fluid 91 chamber 82, and the second sensor 39 is configured to detect a second condition of the second fluid chamber 85. In certain embodiments, the plural component applicator 10 can provide that the internal control unit 80 is a printed circuit assembly, wherein the printed circuit assembly comprises a button battery space 109. According to certain embodiments, the plural component applicator 10 can provide that the internal control unit 80 comprises memory, wherein the memory is configured to store data received from the first sensor 38 and second sensor 39. According to certain embodiments, the plural component applicator 10 can provide that the internal control unit 80 comprises I/O port 109, wherein the I/O port 109 is configured to interface with an external computer system to output data from the memory to the computer system. According to certain embodiments, the plural component applicator 10 can provide that the internal control unit 80 comprises an accelerometer 115. In certain embodiments, the plural component applicator 10 can provide that the accelerometer 115 is configured to power down the plural component applicator 10 based on a predetermined passage of time with no detected movement. According to certain embodiments, the plural component applicator 10 can provide that the accelerometer 115 is configured to store changes in motion in the memory. According to certain embodiments, the plural component applicator 10 can provide that the internal control unit 80 further comprises a plurality of optical indicators 61. In some embodiments, the plural component applicator 10 can include comprising a rear hood 31, wherein the rear hood 31 comprises grooves 118 for each of the plurality of optical indicators 61.

The plural component applicator 10 can include a gun body 16; a nozzle 13; a handle 34; a first hose configured to deliver a first fluid 91 to a first chamber in a manifold 19 based on actuation of a trigger assembly 25; and a second hose configured to deliver a second fluid to a second chamber in a manifold 19 based on actuation of the trigger assembly 25; wherein actuation of the trigger assembly 25 is configured to rotate a cam 40 against a rear external surface 43 of the manifold 19, thereby acting with a force against that of a first needle valve spring 56 and a second needle valve spring 57. In certain embodiments, the plural component applicator 10 can provide that the rear external surface 43 of the manifold 19 comprises a notch portion 121, wherein the cam 40 comprises a perpendicular end portion 124, wherein the perpendicular end portion 124 is configured to fit within the notch portion 121 based on the trigger 46 being fully actuated against the handle 34. In certain embodiments, the plural component applicator 10 can provide that the cam 40 is directly connected to a trigger lock mechanism 64. According to some embodiments, the plural component applicator 10 can provide that the cam 40 and trigger lock mechanism 64 form an integral piece 127. In some embodiments, the plural component applicator 10 can provide that the trigger lock mechanism 64 comprises a fork portion 130 configured to slide within the handle 34 based on actuation of the trigger lock mechanism 64. According to some embodiments, the plural component applicator 10 can provide that the trigger assembly 25 comprises a trigger 46, wherein actuation of the trigger 46 is prevented by the trigger lock mechanism 64 when the trigger lock mechanism 64 is not actuated, and wherein actuation of the trigger 46 is enabled by actuation of the trigger lock mechanism 64. In certain embodiments, the plural component applicator 10 can provide that rotation of the cam 40 against the external surface of the manifold 19 increases a trigger 46 moment directly with increasing opposite force from the first needle valve spring 56 and second needle valve spring 57.

According to some embodiments, the plural component applicator 10 can provide that the first hose is circumscribed by the handle 34 and connects to a manifold 19 bottom surface 133 through a first hose fitting 97 and first hose o-ring 94, wherein the second hose connects to the manifold 19 bottom surface 133 through a second hose fitting 98 and second hose o-ring 95. In certain embodiments, the plural component applicator 10 can provide that the gun body 16 comprises a front face with a plurality of gun body front face notches 139, wherein the manifold 19 comprises a corresponding set of protrusions 142 configured to fit through the gun body front face notches 139. In some embodiments, the plural component applicator 10 can provide that the nozzle 13 comprises at least one alignment guide 145 and the gun body 16 comprises a visual indicator of an unlocked position 149 of the nozzle 13 relative to the gun body 16, wherein the alignment guide 145 can be attached and removed from the gun body 16 when the alignment guide 145 is aligned with the visual indicator of the unlocked position 148. In certain embodiments, the plural component applicator 10 can provide that the gun body 16 comprises a visual indicator of a locked position 149 of the nozzle 13 relative to the gun body 16, wherein the alignment guide 145 can be moved from the unlocked position 149 to the locked position 149 to attach the gun body 16. In some embodiments, the plural component applicator 10 can provide that the nozzle 13 comprises a nozzle back face 151 comprising nozzle notches 159 corresponding to the set of protrusions 142, wherein when the nozzle 13 guide is in the unlocked position 149, the nozzle notches 159 align with the protrusions 142, wherein movement of the nozzle 13 guide from the unlocked to the locked position 149 moves the nozzle notches 159 away from the protrusions 142 and locks the nozzle 13 to the gun body 16 by placing the nozzle back face 151 between the protrusions 142 and the gun body front face 136.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

We claim:

1. A plural component applicator, comprising:
a nozzle attached to a gun body, wherein the gun body comprises a manifold configured to receive a plurality of components based on operation of a trigger assembly, wherein the manifold is configured to separately deliver the plurality of components to a static mixer within the nozzle based on operation of the trigger assembly.

2. The plural component applicator of claim 1, wherein the gun body comprises a rear hood and handle.

3. The plural component applicator of claim 2, wherein the manifold is configured to snap fit into the handle and rear hood.

4. The plural component applicator of claim 2, wherein the rear hood is configured to snap fit into the handle.

5. The plural component applicator of claim 1, further comprising at least one temperature sensor.

6. The plural component applicator of claim 1, wherein the trigger assembly comprises a cam configured to rotate against a rear external surface of the manifold.

7. The plural component applicator of claim 6, wherein the trigger assembly comprises a trigger configured to increase a lever moment based on actuation of the trigger.

8. The plural component applicator of claim 7, further comprising a plurality of needle valves and springs, wherein the lever moment is configured to counteract an increasing force of the springs based on actuation of the trigger to thereby operate the needle valves.

9. The plural component applicator of claim 1, further comprising at least one optical indicator, wherein the at least one optical indicator is configured to optically transmit information related to battery power, trigger actuation, temperature conditions, pressure conditions, or combinations thereof.

10. The plural component applicator of claim 1, further comprising a trigger lock mechanism configured to prevent accidental actuation and dispensing.

11. The plural component applicator of claim 1, further comprising a plurality of hoses, wherein the hoses are configured to enter the manifold through the handle.

12. The plural component applicator of claim 1, wherein the manifold is configured to sacrificially and deterministically burst based on a material overpressure situation.

13. The plural component applicator of claim 1, wherein the applicator comprises an integral hook.

14. The plural component applicator of claim 1, further comprising a hand grip, a finger shelf, and surface texturing.

15. The plural component applicator of claim 1, further comprising a internal control unit housed within the gun body configured to reduce a battery drain when the applicator is not in use and to store performance information.
